(19) United States
(12) Patent Application Publication
(10) Pub. No.: US 2002/0125969 A1
(43) Pub. Date: Sep. 12, 2002

(54) Dielectric filter, dielectric duplexer, and communication device

(76) Inventors: Hajime Suemasa, Mattou-shi (JP); Takashi Maruyama, Kanazawa-shi (JP)

Correspondence Address: DICKSTEIN SHAPIRO MORIN & OSHINSKY LLP, Steven I. Weisburd, 41st Floor, 1177 Avenue of the Americas, New York, NY, 10036-2714, US

(21) Appl. No.: 10/079,847

(22) Filed: Feb. 22, 2002

(30) Foreign Application Priority Data
Feb. 22, 2001 (JP) 2001-046953
Dec. 13, 2001 (JP) 2001-380594

(51) Int. Cl. H01P 1/213; H01P 1/205

(52) U.S. Cl. 333/134; 333/202; 333/206

(57) ABSTRACT

A low-profile dielectric filter includes a dielectric substrate having an opening that extends from a top to a bottom surface of the substrate. A bottom electrode is bonded to the bottom surface of the dielectric substrate, covering the opening to define a depression. Dielectric resonators are mounted in the depression, the bottom electrode serving as a weight-bearing support surface for the dielectric resonators. A plurality of electric devices, such as a resistor, a diode and an air-core coil, are mounted to the dielectric substrate, and a top electrode is mounted to the top surface of the dielectric substrate. The top electrode connects the dielectric resonators and the electric devices. A cover is placed so as to cover the area in which the resonators are mounted.

### BACKGROUND OF THE INVENTION

1. Field of the Invention

The present invention relates to a dielectric filter, a dielectric duplexer, and to a communications device that incorporates either one or both of these.

2. Description of the Related Art

Known dielectric filters comprise dielectric resonators and various electric devices (such as diodes, coils, resistors, or covers), mounted on a dielectric substrate. Such filters are commonly used in radio-frequency communication devices. Increasing consumer demand for ever smaller communication devices has resulted in a corresponding need for smaller, lower-profile dielectric filters.

Japanese Unexamined Patent Application Publication No. 6-276002 (Japan '002) describes a known design for a low-profile dielectric filter. The dielectric filter comprises a ceramic multilayered substrate with a depression formed in at least one layer of the substrate. Dielectric resonators are mounted in the depression, and are connected to a circuit formed on the ceramic multilayered substrate. Electric devices are mounted on other portions of the ceramic multilayered substrate.

Another known low-profile dielectric filter is disclosed in Japanese Unexamined Patent Application Publication No. 11-112110 (Japan '110). A depression is formed in a given portion of a ceramic multilayered substrate, leaving at least a single layer of the ceramic multilayered substrate. Both dielectric resonators and electric devices are mounted in the depression. On the bottom surface of the depression a circuit is formed, to which the dielectric resonators are connected.

However, the dielectric filters described in Japan '002 and Japan '110 each comprise multilayered ceramic substrates as base substrates. Ceramic substrates are very expensive and, as a result, the cost of producing such dielectric filters is quite high.

Another publication, Japanese Unexamined Patent Application Publication No. 6-326504 (Japan '504), describes a different design for a low-profile dielectric filter. A penetrating hole, of the same shape as a set of dielectric resonators, is made in a dielectric substrate. The dielectric resonators are placed in the hole and are connected to a circuit formed on the dielectric substrate.

However, the dielectric filter described in Japan '504 requires an additional structure, that covers the penetrating hole, on which the dielectric resonators may rest. The additional structure must also be evenly flat to maintain a low-profile for the resonators. Although a dielectric substrate would provide such a surface, incorporating an additional dielectric substrate unacceptably increases the cost of the filter.

Japanese Unexamined Patent Application Publication No. 8-97607 (Japan '607) describes a dielectric substrate for a low-profile dielectric filter. Dielectric resonators are mounted in a depression carved in the substrate. In addition, a conductive layer is added to the bottom surface of the depression.

The problem with the dielectric substrate described in Japan '607 is that, because the substrate is so thin, it is difficult to carve out the depression precisely. Each of insulating layers of the multilayered substrate is less than 0.1 mm thick and the conductive layer is only about 18 μm thick. The depression is typically carved out using a device such as a router. To use a router to form a depression to such precise measurements requires a number of additional processing steps that accordingly add to the cost of the dielectric filter. Moreover, the bottom of the depression in may turn out uneven, which will cause the obtained dielectric filter to have an uneven (i.e., higher) profile.

### SUMMARY OF THE INVENTION

Accordingly, it is an object of the present invention to provide (i) a low-profile dielectric filter comprising a dielectric substrate on which a plurality of dielectric resonators and a plurality of electric devices are mounted; (ii) a dielectric duplexer; and (iii) a communication device.

In accordance with an embodiment of the present invention, a dielectric filter comprises a dielectric substrate having an opening extending from a top to a bottom surface thereof; a bottom electrode located on the bottom surface of the dielectric substrate and covering the opening to define a depression; at least one dielectric resonator mounted in the depression, each resonator including an inner conductor; a plurality of electric devices mounted to the dielectric substrate; and a top electrode mounted to the top surface of the dielectric substrate, the top electrode connecting the dielectric resonators and the electric devices. Accordingly, the present invention provides a low-profile dielectric filter that is both stable and low in cost.

Preferably, parts of the bottom electrode function as input/output (I/O) electrodes. As a result, the dielectric filter has a lower profile, and is readily mounted on other mounting boards.

The dielectric substrate is preferably a multilayered dielectric substrate comprising a plurality of insulating layers and a plurality of intermediate-electrode layers. The insulating layers may be made from, for example, a resin. Thus, the present invention provides a small, low-profile, stable dielectric filter with a complex circuit.

Preferably, the dielectric filter further comprises a resist film formed on the bottom surface of the depression. The resist film prevents the electrodes, the electric devices, and the dielectric resonators from undesirable short-circuits and results in a highly reliable dielectric filter.

Preferably, the dielectric filter further comprises a cover for covering at least the area on which the resonators are mounted. The cover has a projection for positioning the cover, and a second depression may be provided into which the projection is inserted. As a result, the strength of the electrical and mechanical connection between the cover and the dielectric substrate is increased and a highly reliable dielectric filter is achieved.

Preferably, the inner conductors and the top electrode are directly connected. Accordingly, a low-cost, low-profile, highly reliable dielectric filter is achieved.

In accordance with another embodiment of the present invention, a dielectric duplexer is provided that comprises any one of the above-described dielectric filters. The dielectric duplexer is highly reliable, small, and has a low-profile.

In accordance with yet another embodiment of the present invention, a communication device comprises any one of the above-described dielectric filters or the dielectric duplexer. The communication device is also highly reliable and small.

### BRIEF DESCRIPTION OF THE DRAWINGS

FIG. 1 is a perspective view of a dielectric filter according to a first embodiment;

FIG. 2A is a perspective view of a dielectric substrate in accordance with the first embodiment;

FIG. 2B is a perspective view of the dielectric substrate in accordance with the first embodiment, when viewed from the undersurface;

FIG. 3A is a cross-sectional side view of the dielectric filter in accordance with the first embodiment;

FIG. 3B is another cross-sectional side view of the dielectric substrate in accordance with the first embodiment;

FIG. 3C is a cross-sectional side view illustrating a part of the dielectric substrate in accordance with the first embodiment;

FIG. 3D is another cross-sectional side view illustrating a part of the dielectric substrate in accordance with the first embodiment;

FIG. 4 is a cross-sectional side view of a dielectric substrate in accordance with a second embodiment;

FIG. 5 is a cross-sectional side view of a dielectric substrate in accordance with a third embodiment;

FIG. 6A is an enlarged cross-sectional side view of a part of a dielectric filter in accordance with a fourth embodiment;

FIG. 6B is another enlarged cross-sectional side view of a part of the dielectric filter in accordance with the fourth embodiment;

FIG. 6C is another enlarged cross-sectional side view of a part of the dielectric filter in accordance with the fourth embodiment;

FIG. 7A is an enlarged cross-sectional side view of a part of a dielectric filter in accordance with a fifth embodiment;

FIG. 7B is another enlarged cross-sectional side view of a part of the dielectric filter in accordance with the fifth embodiment;

FIG. 8 is an enlarged cross-sectional side view of a part of a dielectric filter in accordance with a sixth embodiment; and

FIG. 9 is a block diagram illustrating a communication device in accordance with an eighth embodiment.

### DESCRIPTION OF THE PREFERRED EMBODIMENTS

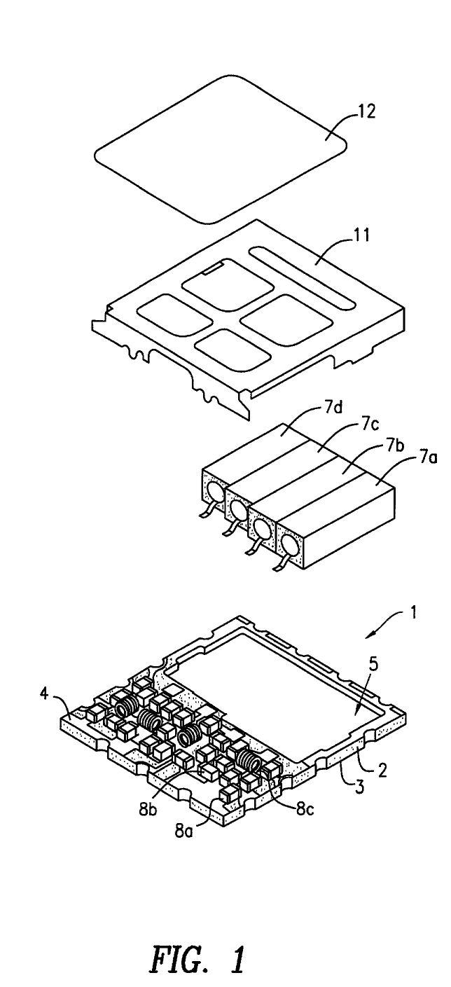

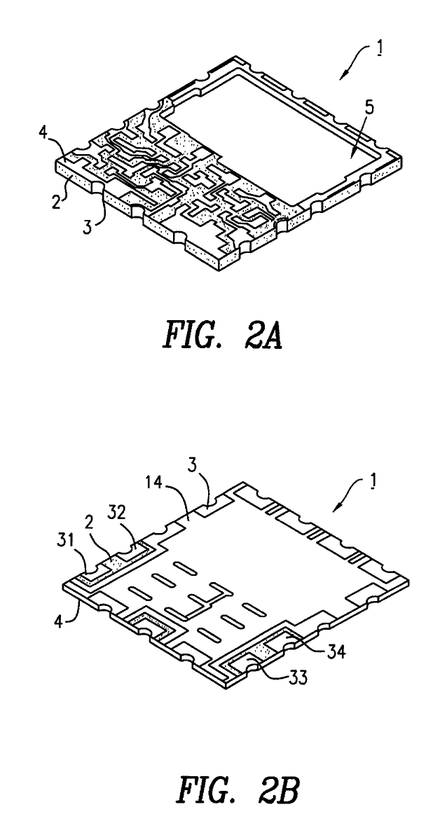

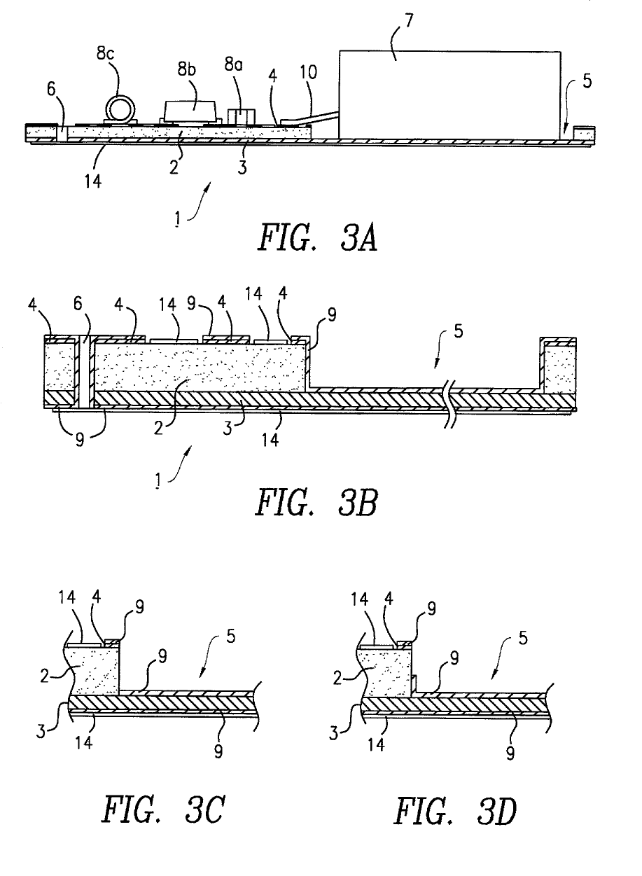

The configuration of a dielectric filter in accordance with a first embodiment will now be described with reference to FIG. 1, FIGS. 2A and 2B, and FIGS. 3A, 3B, 3C, and 3D.

FIG. 1 is an exploded perspective view of a dielectric filter. FIG. 2A is a perspective view of a dielectric substrate, while FIG. 2B is a perspective view of the dielectric substrate when viewed from the undersurface. FIG. 3A is a cross-sectional side view illustrating the configuration of the dielectric filter, while FIGS. 3B, 3C, and 3D are cross-sectional side views of the dielectric substrate.

As shown in these drawings, the dielectric filter comprises the dielectric substrate 1, an insulating layer 2 (preferably formed of resin), a bottom electrode 3, a top electrode 4, a depression 5, a via hole 6, dielectric resonators 7a, 7b, 7c, and 7d, each including an inner conductor, electric devices 8a, 8b, and 8c, via-hole-plating layers 9, connecting conductors 10, a cover 11, a label 12, resist films 14, and I/O electrodes 31, 32, 33, and 34.

As shown in FIG. 3B, the dielectric substrate 1 is formed by the resin-insulating layer 2 on which the top electrode 4, having a thickness of, for example, 18 μm, is formed on one of the surfaces thereof. The surface of the top electrode 4 may, by way of example, be Ni plated or Au plated. Further, a penetrating through hole having a predetermined shape is formed in the resin-insulating layer 2, preferably using a press or the like. A bottom electrode 3, preferably having a thickness of about 15 to 150 μm, is provided over most of the bottom surface of the resin-insulating layer 2, preferably by thermocompression bonding. The bottom electrode 3 serves as a weight-bearing support surface for the dielectric resonators 7a-d. As a result, the bottom of the penetrating hole is covered by the bottom electrode 3 (FIGS. 3A and 3B) whereby a depression 5 in which the dielectric resonators 7a-d can be mounted is formed.

The resin-insulating layer 2 is preferably formed by a low dielectric constant resin comprising a base material made of fiberglass. The bottom electrode 3 is preferably formed from a copper foil which is subjected to Cu plating, Ni plating, and Au plating in that order.

After providing the via hole 6 (FIGS. 3A and 3B) in the dielectric substrate 1 at a predetermined position, the via-hole-plating layers 9 are formed so as to connect the top electrode 4 and the bottom electrode 3. The top electrode 4 and the bottom electrode 3 are patterned, developed, and etched, whereby the top electrode 4 functions as a desired circuit as shown in FIG. 2A, and the I/O electrodes 31 to 34 are formed separate from the bottom electrode 3 (which functions as a ground electrode), as shown in FIG. 2B. The via-hole-plating layers 9 formed on the wall surface of the depression 5 are preferably formed in a given shape by etching or the like as shown in FIGS. 3B, 3C, and 3D.

The resist films 14 are formed on predetermined positions on the top and bottom surfaces of the dielectric substrate 1.

Electric devices 8a, 8b, and 8c may be, for example, a resistor, a diode, and an air-core coil. They are mounted on the dielectric substrate 1 at predetermined positions as shown in FIG. 3A. The dielectric resonators 7a to 7d are fitted in the depression 5. The inner conductors of the dielectric resonators 7a to 7d are connected to predetermined portions of the top electrode 4 by connecting conductors 10.

Thus, the dielectric resonators 7a to 7d and the electric devices 8a to 8c are mounted on the dielectric substrate 1. Then, a cover 11 is placed over the dielectric substrate 1 to cover the surface on which the dielectric resonators 7a to 7d and the electric devices 8a to 8c are mounted, as shown in FIG. 1. Subsequently, the label 12 on which the manufacturing information is printed is placed over the surface of the cover 11. Accordingly, the dielectric filter is formed.

According to the configuration, the depression 5, which has the undersurface on which the dielectric resonators 7a to 7d are disposed, can be formed by a dielectric substrate comprising a single layer. Since the bottom electrode 3 functions as the undersurface of the depression 5, the dielectric filter is readily provided at low cost.

The laminating process used for regular multilayered dielectric substrates can be used to provide the bottom electrode 3 on the dielectric substrate 1 by thermocompression bonding.

The undersurface of the depression 5 is formed by only the bottom electrode 3 and the via-hole-plating layer 9. Therefore, the dimensional precision of the thickness of the undersurface of the depression 5 is high, and the height of the plurality of dielectric resonators 7a to 7d is even. As a result, a low-profiled dielectric filter is readily provided.

Since the I/O electrodes 31 to 34 are formed as parts of the bottom electrode 3, the dielectric filter can be readily mounted on another mounting board.

In this embodiment, the bottom electrode 3 is formed on one of the main surfaces of the dielectric substrate 1. However, the bottom electrode 3 may be formed so as to cover, for example, at least the opening of the depression 5 provided in the dielectric substrate 1.

Further, the bottom electrode 3 is preferably formed by a metal film made of metal (copper) foil having a surface which is subjected to metal plating. However, a sheet-like dielectric material such as polyimide having a metal-plated surface may be used as the bottom electrode 3.

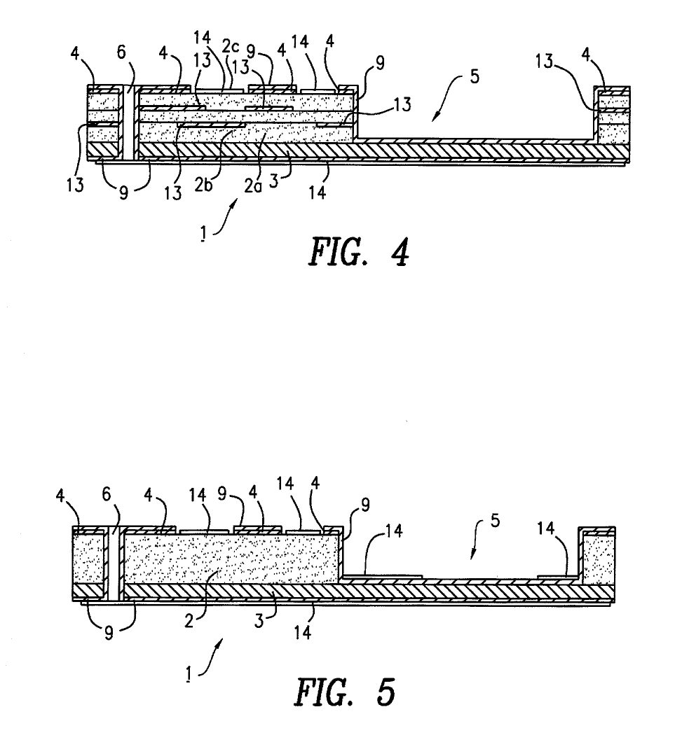

The configuration of a dielectric filter according to a second embodiment will now be described with reference to FIG. 4.

FIG. 4 is a cross-sectional side view of the dielectric filter.

The dielectric filter comprises a dielectric substrate 1, resin-insulating layers 2a, 2b, and 2c, a bottom electrode 3, a top electrode 4, a depression 5, a via hole 6, via-hole-plating layers 9, intermediate electrodes 13, and resist films 14.

The configuration of this dielectric filter is similar to the dielectric filter of the first embodiment except that a multilayered dielectric substrate is used as the dielectric substrate 1, which is obtained by laminating the plurality of resin-insulating layers 2a to 2c and the plurality of intermediate electrodes 13.

According to this embodiment, the depression 5 can be readily formed, and the dimensional precision of the undersurface of the depression 5 can be increased by using the multilayered dielectric substrate of the related art. Therefore, a low cost dielectric filter which is small and low-profiled, comprising the multilayered dielectric substrate on which complex circuits can be formed, is readily provided.

The configuration of a dielectric filter according to a third embodiment will now be described with reference to FIG. 5.

FIG. 5 is a cross-sectional side view of the dielectric filter comprising a dielectric substrate 1, resin-insulating layers 2, a bottom electrode 3, a top electrode 4, a depression 5, a via hole 6, via-hole-plating layers 9, and resist films 14.

The structure of the dielectric filter shown in FIG. 5 is similar to that of the electric filter of the first embodiment except that the resist films 14 are disposed on the undersurface of the depression 5 at predetermined positions.

According to this embodiment, the top electrode 4, the bottom electrode 3, the electric devices 8a to 8c, and the dielectric resonators 7a to 7d are prevented from being short-circuited at unnecessary parts. Therefore, the obtained dielectric filter achieves high reliability.

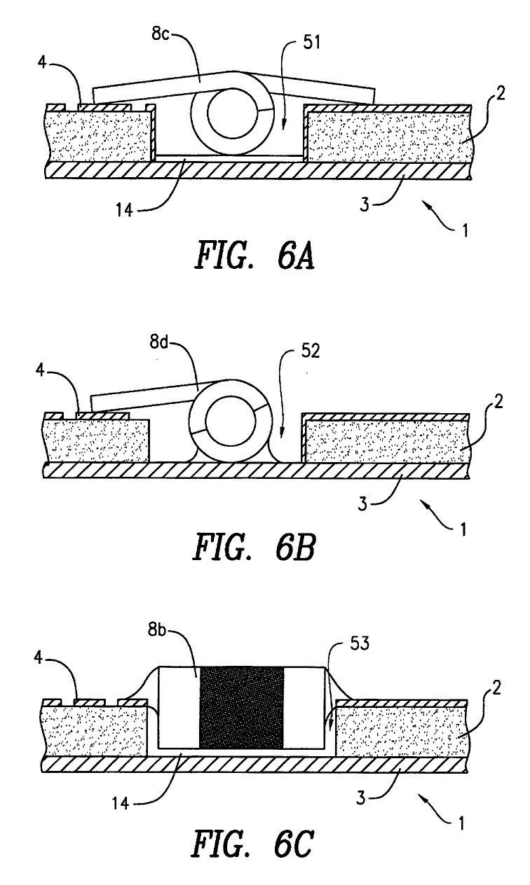

The configuration of a dielectric filter according to a fourth embodiment will now be described with reference to FIGS. 6A, 6B, and 6C.

In these drawings, a dielectric substrate 1, a resin-insulating layer 2, a bottom electrode 3, a top electrode 4, depressions 51, 52, and 53, a chip 8b such as a resistor, air-core coils 8c and 8d, and resist films 14 are shown.

The dielectric filter of this embodiment is similar to the dielectric filter in the first embodiment except that the depressions 51 to 53 are provided as in the case of the depression 5 shown in FIG. 1 on the dielectric substrate 1 at positions where the chip 8b and the air-core coils 8c and 8d are to be mounted.

That is, the chip 8b is fitted in the depression 53 as shown in FIG. 6C, the air-core coil 8c is fitted in the depression 51 as shown in FIG. 6A, and the air-core coil 8d is fitted in a depression 52 as shown in FIG. 6B.

This configuration lowers the height of the chip 8b and the air-core coils 8c and 8d when mounted to the dielectric substrate 1, resulting in a low-profile dielectric filter.

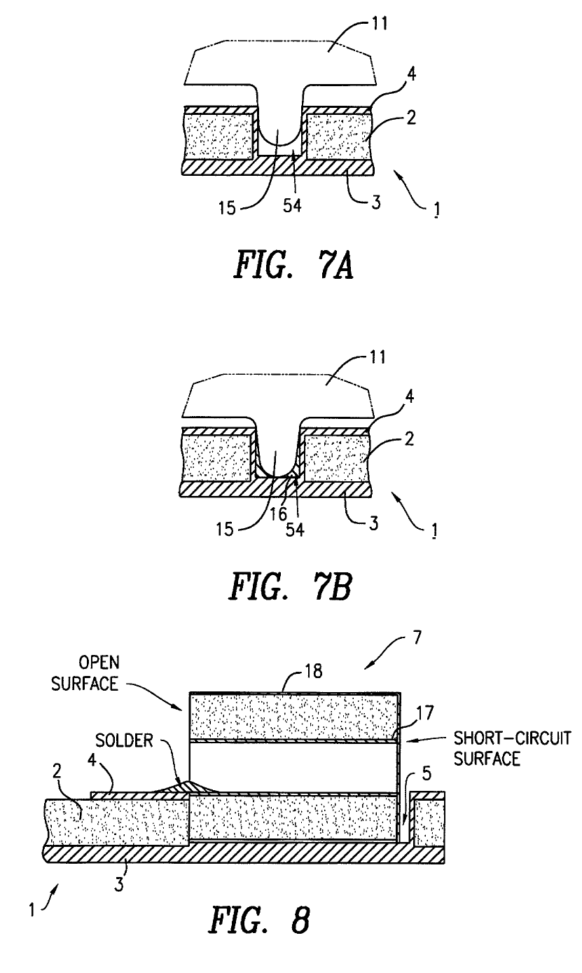

The configuration of a dielectric filter according to a fifth embodiment will now be described with reference to FIGS. 7A and 7B.

In these drawings, a dielectric substrate 1, resin-insulating layer 2, a bottom electrode 3, a top electrode 4, a depression 54, a cover 11, a projection 15 for positioning the cover 11 (hereinafter referred to as the projection 15), a conductive-bonding material 16 are shown.

This dielectric filter is configured as in the case of the dielectric filter in the first embodiment except that the projection 15 is provided at a given position of the cover 11. The projection 15 is press-fitted and is inserted in the depression 54 (which is provided on the dielectric substrate l) for positioning the cover 11.

Accordingly, the cover 11 is easily positioned and establishes stable electrical and mechanical connections. By using conductive-bonding material, e.g., solder, or conductive adhesive as shown in FIG. 7B, the connections are made even more stable.

The bottom electrode 3, which functions as the undersurface of the depression 54, prevents the projection 15 from penetrating the dielectric substrate 1. The bottom electrode 3 can also prevent the conductive-bonding material from traveling to the undersurface of the dielectric substrate 1. Accordingly, the undersurface of the dielectric substrate 1 becomes flat, whereby deterioration of the evenness of the dielectric filter is prevented.

The configuration of a dielectric filter according to a sixth embodiment will now be described with reference to FIG. 8.

In FIG. 8, a dielectric substrate 1, a resin-insulating layer 2, a bottom electrode 3, a top electrode 4, a depression 5, a dielectric resonator 7, an inner conductor 17 of the dielectric resonator 7, and an outer electrode 18 of the dielectric resonator 7 are shown.

The structure of the dielectric filter shown in FIG. 8 is similar to the structure of the dielectric filter in the first embodiment, except that the inner conductor 17 is directly soldered to the top electrode 4. The depth of the depression 5 is predetermined so that the inner conductor 17 and the top electrode 4 are directly connected.

Since no connecting conductors are required in the above configuration, the number of parts is reduced, and the connection parts are smaller in size. Accordingly, the dielectric filter which is smaller and inexpensive is achieved.

The dielectric filter of FIG. 1 can be used in a dielectric duplexer by using a plurality of dielectric filters for transmitting and receiving signals.

Similarly, the dielectric duplexer may use the dielectric resonators 7a and 7b of the dielectric filter shown in FIG. 1 as a transmission filter, and may use the dielectric resonators 7c and 7d of the dielectric filter shown in FIG. 1 as a reception filter. Further, a shared electrode which is connected to these filters may be provided on the dielectric substrate 1, whereby the dielectric duplexer is achieved.

Accordingly, a dielectric duplexer which is highly reliable, small, and low-profiled is readily provided at low cost.

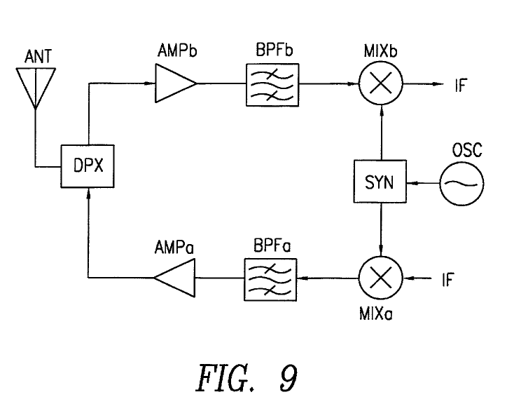

The configuration of a communication device according to an eighth embodiment will now be described with reference to FIG. 9.

The communication device comprises a transmission/reception antenna ANT, a duplexer DPX, bandpass filters BPFa and BPFb, amplifying circuits AMPa and AMPb, mixers MIXa and MIXb, an oscillator OSC, and a synthesizer SYN. Further, intermediate-frequency signals IF are shown.

The dielectric filter shown in FIG. 1 may be used, for example, as the bandpass filter BPFa and BPFb. For the duplexer DPX, the dielectric duplexer having the plurality of dielectric filters shown in FIG. 1, or the dielectric duplexer, which is obtained by modifying the circuit configuration of the dielectric filter shown in FIG. 1 as described in the seventh embodiment, may be used. By using these dielectric filters and the dielectric duplexer, which are highly reliable, small, and low-profiled, the obtained communication device becomes highly reliable and small.

What is claimed is:

1. A dielectric filter comprising:
a dielectric substrate having an opening extending from a top to a bottom surface thereof;
a bottom electrode located on the bottom surface of the dielectric substrate and covering the opening to define a depression;
at least one dielectric resonator mounted in the depression, each resonator including an inner conductor;
a plurality of mounted electric devices; and
a top electrode mounted to the top surface of the dielectric substrate, the top electrode connecting the dielectric resonators and the electric devices.

2. A dielectric filter according to claim 1, wherein the bottom electrode is a weight-bearing support surface for the dielectric resonators.

3. A dielectric filter according to claim 1, wherein the plurality of mounted electric devices are mounted to the dielectric substrate.

4. A dielectric filter according to claim 1, wherein one or more of the plurality of mounted electric devices are mounted in a second depression formed by a second opening extending from the top surface to the bottom surface of the dielectric substrate, and the bottom electrode.

5. A dielectric filter according to claim 1, further comprising I/O electrodes on the surface of the bottom electrode.

6. A dielectric filter according to claim 1, further comprising:
a via hole through the dielectric substrate; and
via-hole-plating-layers connecting the top electrode to the bottom electrode.

7. A dielectric filter according to claim 1, wherein the dielectric substrate is a multilayered dielectric substrate comprising:
a plurality of insulating layers; and
a plurality of intermediate-electrode layers.

8. A dielectric filter according to claim 1, further comprising a resist film formed on the bottom surface of the depression.

9. A dielectric filter according to claim 1, further comprising:
a cover including a projection for positioning the cover, wherein the cover covers at least the area to which the dielectric resonators are mounted; and
a second depression for receiving the projection, the second depression formed by a second opening extending from the top surface to the bottom surface of the dielectric substrate, and the bottom electrode.

10. A dielectric filter according to claim 1, wherein the inner conductor of the dielectric resonator is connected to the top electrode.

11. A dielectric duplexer comprising a dielectric filter, the dielectric filter further comprising:
a dielectric substrate having an opening extending from a top to a bottom surface thereof;
a bottom electrode located on the bottom surface of the dielectric substrate and covering the opening to define a depression;
at least one dielectric resonator mounted in the depression, each resonator including an inner conductor;
a plurality of electric devices mounted to the dielectric substrate; and
a top electrode mounted to the top surface of the dielectric substrate, the top electrode connecting the dielectric resonators and the electric devices.

12. A dielectric duplexer according to claim 11, wherein the dielectric filter further comprises a plurality of dielectric resonators, one or more of which are used to transmit signals and one or more of which are used to receive signals.

13. A dielectric duplexer according to claim 11, further comprising a plurality of dielectric filters, each dielectric filter including a third electrode for connecting the dielectric filters to each other.

14. A dielectric duplexer according to claim 11, wherein the dielectric substrate of the dielectric filter is a multilayered dielectric substrate comprising:
a plurality of insulating layers; and
a plurality of intermediate-electrode layers.

15. A dielectric duplexer according to claim 11, wherein the dielectric filter further comprises a resist film formed on the bottom surface of the depression.

16. A dielectric duplexer according to claim 11, wherein the inner conductor of the dielectric resonator is connected to the top electrode.

17. A communication device comprising:
a transmission/reception antenna;
a duplexer;
an amplifying circuit;
a mixer;
an oscillator;
a synthesizer; and
a bandpass filter, wherein the bandpass filter is a dielectric filter including:
a dielectric substrate having an opening extending from a top to a bottom surface thereof;
a bottom electrode located on the bottom surface of the dielectric substrate and covering the opening to define a depression;
at least one dielectric resonator mounted in the depression, each resonator including an inner conductor;
a plurality of electric devices mounted to the dielectric substrate; and
a top electrode mounted to the top surface of the dielectric substrate, the top electrode connecting the dielectric resonators and the electric devices.

18. A communication device according to claim 17, wherein the duplexer further comprises a second dielectric filter, the second dielectric filter including:
a dielectric substrate having an opening extending from a top to a bottom surface thereof;
a bottom electrode located on the bottom surface of the dielectric substrate and covering the opening to define a depression;
at least one dielectric resonator mounted in the depression, each resonator including an inner conductor;
a plurality of electric devices mounted to the dielectric substrate; and
a top electrode mounted to the top surface of the dielectric substrate, the top electrode connecting the dielectric resonators and the electric devices.

19. A communication device according to claim 17, wherein the dielectric substrate is a multilayered dielectric substrate comprising:
a plurality of insulating layers; and
a plurality of intermediate-electrode layers.

20. A communication device according to claim 17, wherein the dielectric filter further comprises a resist film formed on the bottom surface of the depression.
